(19) United States
(12) Patent Application Publication
(10) Pub. No.: US 2002/0017208 A1
(43) Pub. Date: Feb. 14, 2002

(54) Lithographic printing method

(75) Inventors: Seishi Kasai, Shizuoka (JP); Eiichi Kato, Shizuoka (JP)

Correspondence Address: SUGHRUE, MION, ZINN, MACPEAK & SEAS, PLLC, 2100 Pennsylvania Avenue, N.W., Washington, DC, 20037, US

(73) Assignee: FUJI PHOTO FILM CO.,LTD.

(21) Appl. No.: 09/898,002

(22) Filed: Jul. 5, 2001

(30) Foreign Application Priority Data
Jul. 4, 2000 (JP) P.2000-202685

(51) Int. Cl. B41N 6/00

(52) U.S. Cl. 101/375; 101/401.1; 101/453

(57) ABSTRACT

A lithographic printing method comprises:

disposing on a plate cylinder, a block copy sheet and a lithographic printing plate, in this order, wherein the block copy sheet has a front surface that is uneven, the lithographic printing plate has a back surface that is uneven, and the front surface of the block copy sheet and the back surface of the lithographic printing plate are opposed to each other; and

carrying out printing with the lithographic printing plate.

### FIELD OF THE INVENTION

The present invention relates to a lithographic printing method using a block copy sheet for lithographic printing, which can avoid positional deviation of a lithographic printing plate on a plate cylinder of a printing machine.

### BACKGROUND OF THE INVENTION

Generally, in printing machines for lithographic printing, a printing plate is wrapped around a plate cylinder and mechanically fixed thereto and, in this state, printing is carried out. As a support for the lithographic printing plate, there have so far been known that which is composed of such material as a metal, plastic film or paper. Lithographic printing plates containing other material than metal as the support have an insufficient dimensional stability, though they are excellent in handling properties.

In lithographic printing, the plate cylinder and the blanket cylinder are different from each other in peripheral speed and, all through printing, a force of elongating the printing plate is generated. Therefore, the lithographic printing plates having a support made of other material than metal cause elongation or positional deviation of the plates during printing, thus it has been difficult to use the plate for full color printing to be pursued an exact accuracy of position.

As means for solving the problem, there have been proposed a method of fixing the printing plate onto the plate cylinder using a spray adhesive (Japanese Patent Laid-Open No. 11258/1981) or a method of fixing the plate by using an adhesive material (Japanese Patent Publication No. 425/1995, Japanese Patent Laid-Open No. 104853/86, etc.). However, once the printing plate is thus fixed to the plate cylinder, it becomes difficult to carry out a fine adjustment of alignment which is necessary in a subsequent step. Thus, in fact, such proposed methods not were effective.

Further, the lithographic printing plates having a support made of other material than metal cause the problem that registering or fixing gripper at the front end of the plate cylinder is difficult due to soft properties of the substrate.

As a means to solve the problem, there has been proposed a method of registering by providing a number of pins which facilitate registering (Japanese Patent Laid-Open No. 24555/1998). However, this method is essentially ineffective for the problem resulting from soft properties of the printing plate.

There has been proposed a plate-engaging method for improving positional accuracy and dimensional accuracy upon high speed printing by using a sheet material having an initial elastic modulus of 300 kgf/mm² or less and, further, for reducing a frictional coefficient between the plate cylinder and the plate by forming an uneven surface (mat surface) through chemical or physical treatment of the surface or through adhesion of fine particles onto the surface of a sheet-like material, to thereby ensure smooth sliding of the printing plate and smooth adjustment of register (Japanese Patent Laid-Open No. 20130/1999). It has been found, however, that this technique fails to sufficiently suppress elongation or positional deviation of the plate, though it enables registering and gripper fixing.

On the other hand, there have been proposed a sheet material containing at least one side of which has an center-line average roughness Ra of 2 μm or more (Japanese Patent Laid-Open No. 193828/1998) and a block copy sheet having an uneven surface where specific minute projections are distributively formed (Japanese Patent Laid-Open No. 59012/1999). These block copy sheets can depress elongation of the lithographic printing plate due to the anchoring effect of the uneven surface into the back side of the lithographic printing plate and, further, enables fine registering by the uneven surface effect. Even these block copy sheets are still insufficient in the effect of preventing elongation or positional deviation of the plate, thus a more excellent method has been desired.

As is described above, in the case of carrying out full color printing using a lithographic printing plate having a support made of other material than metal, there has been no techniques which can fully prevent elongation and positional deviation of the plate, thus full color printing using such lithographic printing plate has been limited to only printing of an extremely small number of sheets.

### SUMMARY OF THE INVENTION

The present invention provides a lithographic printing method which secures prevention of elongation and positional deviation of a lithographic printing plate mounted on a plate cylinder thereby permitting, for example, a lithographic printing plate having a support made of other material than metal to be applied to multi-color printing of a large number of sheets.

Further, the invention provides a lithographic printing method which does not cause stain in a non-image area and which can secure prevention of elongation and positional deviation of the lithographic printing plate.

The present invention is constituted by one of the following constitutions (1) to (17):

(1) A lithographic printing method comprising:

disposing on a plate cylinder, a block copy sheet and a lithographic printing plate, in this order, wherein the block copy sheet has a front surface that is uneven, the lithographic printing plate has a back surface that is uneven, and the front surface of the block copy sheet and the back surface of the lithographic printing plate are opposed to each other; and

carrying out printing with the lithographic printing plate.

(2) The lithographic printing method described in item (1) wherein the front surface of the block copy sheet and the back surface of the lithographic printing plate are engaged with each other.

(3) The lithographic printing method described in item (1) wherein the front surface of the block copy sheet has a center-line average roughness: Ra of 20 μm or less.

(4) The lithographic printing method described in item (1) wherein the front surface of the block copy sheet has a center-line average roughness: Ra of 12 μm or less.

(5) The lithographic printing method described in item (1), wherein the front surface of the block copy sheet has a center-line average roughness: Ra of less than 2 μm.

(6) The lithographic printing method described in item (1), wherein the front surface of the block copy sheet has a ratio of a center-line average roughness: Ra to a ten-point average roughness: Rz (Ra/Rz) of less than 0.17.

(7) The lithographic printing method described in item (1), wherein the back surface of the lithographic printing plate has a center-line average roughness: Ra of 20 μm or less.

(8) The lithographic printing method described in item (1) wherein the back surface of the lithographic printing plate has a center-line average roughness: Ra of 12 μm or less.

(9) The lithographic printing method described in item (1) wherein the back surface of the lithographic printing plate has a center-line average roughness: Ra of less than 1.5 μm. (10) The lithographic printing method described in item (1), wherein a sum of Ra of the front surface of the block copy sheet and Ra of the back surface of the lithographic printing plate is 20 μm to 0.1 μm.

(11) The lithographic printing method described in item (1), wherein the block copy sheet comprises a support, and the support has an initial elastic modulus of 350 kgf/mm² or more.

(12) The lithographic printing method described in item (1) wherein the uneven surface is obtained by coating on the support a dispersion where particles having an average particle size of 1 to 100 μm are dispersed in a binder resin.

(13) The lithographic printing method described in item (12), wherein the binder resin comprises an inorganic resin containing at least one bond structure selected from the group consisting of O—(M)—O, O—(M)—N and N—(M)—N, in which M represents a metal atom, O represents an oxygen atom and N represents a nitrogen atom.

(14) The lithographic printing method described in item (12), wherein the binder resin is a composite comprising an inorganic resin and an organic polymer containing a group capable of forming a hydrogen bond with the inorganic resin.

(15) The lithographic printing method described in item (14), wherein the group capable of forming a hydrogen bond with the inorganic resin is at least one selected from the group consisting of an amido group, an urethane group, an ureido group and a hydroxyl group.

(16) The lithographic printing method described in item (14), wherein the weight ratio of the inorganic resin to the organic polymer in the composite is 10/90 to 90/10.

(17) The lithographic printing method described in item (12), wherein the binder resin is used in an amount of 8 to 50 parts by weight, per 100 parts by weight of the particles.

In the present invention, uneven surface is formed on both the block copy sheet and the back side of lithographic printing plate, and the uneven surfaces engage with each other to extremely effectively prevent elongation or positional deviation of the lithographic printing plate during printing.

### DETAILED DESCRIPTION OF THE INVENTION

The block copy sheet of the invention is first described in detail below.

As the support of the block copy sheet, there are used, for example, a metal plate, a resin sheet and a metal-resin composite sheet and, more preferably, there are illustrated a metal plate such as an aluminum plate, a zinc plate, a titanium plate or a stainless steel plate; a bimetal plate such as a copper-aluminum plate, a copper stainless steel plate or a chromium-copper plate; a trimetal plate such as a chromium-copper-aluminum plate, a chromium-lead-iron plate or a chromium-copper-stainless steel plate; a resin sheet such as a PET sheet, a PE sheet, a PP sheet, a polyester sheet, a polyimide sheet, a polyamide sheet or an acrylic resin sheet; and a metal-resin composite sheet such as an aluminum-PET sheet, an aluminum-PE sheet, an aluminum-polyester sheet, a titanium-PET sheet or a titanium-PE sheet. The metal sheet such as the aluminum sheet or the stainless steel sheet, the resin sheet such as the PET sheet or the PE sheet and the metal-resin composite sheet such as the aluminum-PET sheet or the aluminum-polyester sheet are more preferred. The support is preferably a sheet-like support having an initial elastic modulus of 350 kgf/mm² or more, more preferably 350 to 5,000 kgf/mm², particularly preferably 350 to 2,000 kgf/mm². Such support can effectively perform its function without the uneven surface being forced to become flat by the pressure. The initial elastic modulus can be measured according to JIS K7127.

As a method for making the uneven front surface of the block copy sheet, there are illustrated a method of coating a dispersion where particles are dispersed in the binder resin, and drying it, a method of forming a binder resin film on the surface, then mechanically pressing particles into the binder resin film, a flame spraying method of spraying a molten metal, a method of blast-treating the surface, a method of gravure coating a curable resin, and a method of processing using a laser. Of these, the method of coating a dispersion where particles are dispersed in the binder resin and the method of forming a binder resin film on the surface, then pressing the particles into the film are preferred.

The above-described particles used for making the surface uneven, preferably have an average particle size of 1 to 100 μm. Particles with an average particle size of 1 to 80 μm are more preferred, with particles having an average particle size of 1 to 50 μm being particularly preferred. Materials of the particles are not particularly limited, and the particles may be made of inorganic materials, organic materials or composite materials of an organic material and an inorganic material. Particles having a hardness higher than that of the back side of the lithographic printing plate support are preferably used.

As the inorganic particles, there are illustrated, for example, metal powders, metal oxides, metal nitrides, metal hydroxides, metal sulfides, metal carbides and composite metal compounds of these materials, and glass, oxides such as SiO₂, TiO₂, ZnO, Fe₂O₃, ZrO₂ and SnO₂, and sulfides such as ZnS and CuS being preferred.

As the organic particles, there are illustrated, for example, synthetic resin particles and natural high molecular particles, and acrylic resin, polyethylene, polypropylene, polyethylene oxide, polypropylene oxide, polyethyleneimine, polystyrene, polyurethane, polyurea, polyester, polyamide, polyimide, carboxymethyl cellulose, gelatin, starch, chitin and chitosan are preferred, and particles of the synthetic resin such as acrylic resin, polyethylene, polypropylene and polystyrene are more preferred.

As the compsite materials of an organic material and an inorganic material, there are illustrated, for example, composites of two or more of the materials forming the above-described inorganic particles and organic particles, and composites between an inorganic material of glass, an oxide such as SiO₂, TiO₂, ZnO, Fe₂O₃, ZrO₂ or SnO₂ and/or a sulfide such as ZnS or CuS and an organic material of acrylic resin, polyethylene, polypropylene, polyethylene oxide, polypropylene oxide, polyethyleneimine, polystyrene, polyurethane, polyurea, polyester, polyamide, polyimide, carboxymethyl cellulose, gelatin, starch, chitin and chitosan are preferred. The composites between an inorganic material of the oxide such as SiO₂, TiO₂, ZnO, Fe₂O₃, ZrO₂ or SnO2 and an organic material having a hydrogen-binding functional group such as acryl resin, polyethylene oxide, polypropylene oxide, polyethyleneimine, polyurethane, polyurea, polyester, polyamide, polyimide, carboxymethyl cellulose, gelatin, starch, chitin and chitosan are more preferred.

As the binder resin for dispersing and binding the particles for forming the uneven surface, all of generally employed natural, semi-synthetic and synthetic resins such as organic resins (oleophilic resins, water-soluble resins, etc.), organic resin emulsions, inorganic resins and hybrid resins between an organic resin and an inorganic resin may be used in the invention, with optionally employing curing treatment.

As the oleophilic organic resins, there are illustrated acrylic resins (e.g., polymethyl methacrylate, polymethyl acrylate, polyethylmethacrylate, various copolymers of alkyl, aralkyl or aryl acrylates, and various copolymers of alkyl, aralkyl or aryl methacrylates), alkyd resins (e.g., melamine resin and phenol resin), polystyrene resin, polyvinyl acetate resin, epoxy resin, polyalkylene resins (e.g., polyethylene and polypropylene), polyester resin and polyurethane resin.

As the water-soluble organic resin, there are illustrated cellulose, cellulose derivatives (e.g., cellulose esters such as cellulose nitrate, cellulose sulfate, cellulose acetate, cellulosepropionate, cellulosesuccinate, cellulosebutyrate, cellulose acetate succinate, cellulose acetate butyrate and cellulose acetate phthalate; cellulose ethers such as methyl cellulose, ethyl cellulose, cyanoethyl cellulose, carboxymethyl cellulose, hydroxyethyl cellulose, hydroxypropyl cellulose, ethylhydroxyethyl cellulose, hydroxypropylmethyl cellulose and carboxymethylhydroxyethyl cellulose), starch, starch derivatives (e.g., oxidized starch; esterified starches such as starches esterified with nitric acid, sulfuric acid, phosphoric acid, acetic acid, propionic acid, butyric acid or succinic acid; and etherified starches such as methylated starch, ethylated starch, cyanoethylated starch, hydroxyalkylated starch and carboxymethylated starch), alginic acid, pectin, carrageenan, tamarind gum, natural gums (e.g., gum arabic, Guar gum, locast bean gum, tragacanth gum and xanthane gum), pullulan, dextran, casein, gelatin, chitin, chitosan, polyvinyl alcohol, polyalkylene glycol [e.g., polyethylene glycol, polypropylene glycol and (ethylene/propylene glycol) copolymer], allyl alcohol copolymers, acrylic acid copolymers, methacrylic acid copolymers, polyaminoacids, polyamides (e.g., homopolymersor copolymers of N-substituted derivatives of acrylamide or methacrylamide [examples of N-substutuent: methyl, ethyl, propyl, isopropyl, butyl, phenyl, monomethylol, 2-hydroxyethyl, 3-hydroxypropyl, 1,1-bis(hydroxymethyl)ethyl, and 2,3,4,5,6-pentahydroxypentyl]), polyamines (e.g., polyethylene imine, polyallylamine and polyvinylamine) and polyurea (e.g., urea resin).

As the organic resin emulsion, there are illustrated emulsions of acrylic resins (e.g., polymethyl methacrylate, polymethyl acrylate, polyethyl methacrylate, various alkyl, aralkyl or aryl acrylate copolymers, and various alkyl, aralkyl or aryl methacrylate copolymers), emulsions of alkyd resins (e.g., melamine resin and phenol resin), styrene resin emulsion, vinyl acetate resin emulsion, epoxy resin emulsion, emulsions of alkylene resins (e.g., polyethylene and polypropylene), ester resin emulsions, urethane resin emulsions, etc.

As the inorganic resin, there are illustrated those resins which have a structure wherein metal atoms are bound to each other via an oxygen atom or nitrogen atom (hereinafter also referred to as “metal-containing resins”). The metal-containing resin is a polymer which mainly contains a bond structure composed of “oxygen atom (nitrogen atom)-metal atom-oxygen atom(nitrogen atom) That is, the bond structure is at least one selected from the group consisted of O—M—O, O—M—N and N—M—N in which O is oxygen atom, M is metal atom and N is nitrogen atom.

Of the metal-containing resins, resins containing the bond structure of oxygen atom-metal atom-oxygen atom are preferably those polymers which are obtained by hydrolytic polycondensation of a metal compound represented by the following general formula (I). The hydrolytic polycondensation reaction is a reaction wherein a reactive group repeatedly undergo hydrolysis and condensation under acidic or basic conditions, thus polymerization taking place.

(R⁰)ₙM(Y)ₓ₋ₙ General formula (I)

wherein R⁰ represents a hydrogen atom, a hydrocarbyl group or a heterocyclic group, Y represents a reactive group, M represents a 3- to 6-valent metal, x represents a valency number of metal M, and n represents 0, 1, 2, 3 or 4, provided that x-n is 2 or more.

The metal compounds represented by the general formula (I) are described in detail below.

R⁰ in the general formula (I) preferably represents an optionally substituted, straight or branched alkyl group containing 1 to 12 carbon atoms {e.g., methyl group, ethyl group, propyl group, butyl group, pentyl group, hexyl group, heptyl group, octyl group, nonyl group, decyl group or dodecyl group; examples of the substituents for these groups being a halogen atom (e.g., chlorine atom, fluorine atom or bromine atom), a hydroxyl group, a thiol group, a carboxyl group, a sulfo group, acyano group, an epoxy group, —OR′ group (wherein R′ represents a hydrocarbyl group such as methyl group, ethyl group, propyl group, butyl group, hexyl group, heptyl group, octyl group, decyl group, propenyl group, butenyl group, hexenyl group, octenyl group, 2-hydroxyethyl group, 3-chloropropyl group, 2-cyanoethyl group, N,N-dimethylaminoethyl group, 2-bromoethyl group, 2-(2-methoxyethyl)oxyethyl group, 2-methoxycarbonylethyl group, 3-carboxypropyl group or benzyl group), —OCOR′ group, —COOR′ group, —COR′ group, a —N(R″) (R″) group (wherein R″ represents a hydrogen atom or is the same as defined with respect to R′, with the two R″s being the same or different from each other), a —NHCONHR′ group, a —NHCOOR′ group, —Si (R′) 3 group, a —CONHR″ group or a —NHCOR′ group; the alkyl group being optionally substituted by a plurality of these substituents)}, an optionally substituted, straight or branched alkenyl group containing 2 to 12 carbon atoms {e.g., vinyl group, propenyl group, butenyl group, pentenyl group, hexenyl group, octenyl group, decenyl group or dodecenyl group; examples of the substituents for these groups being the same as defined with respect to the above-described alkyl group, and the alkenyl group being optionally substituted by a plurality of the substituents), an optionally substituted aralkyl group containing 7 to 14 carbon atoms (e.g., benzyl group, phenethyl group, 3-phenylpropyl group, naphthylmethyl group or 2-naphthylethyl group; examples of the substituents for these groups being the same as defined with respect to the above-described alkyl group, and the aralkyl group being optionally substituted by a plurality of the substituents), an optionally substituted alicyclic group containing 5 to 10 carbon atoms (e.g., cyclopentyl group, cyclohexyl group, 2-cyclohexylethyl group, 2-cyclopentylethyl group, norbornyl group or adamantyl group; examples of the substituents for these groups being the same as defined with respect to the above-described alkyl group, and the alicyclic group being optionally substituted by a plurality of the substituents), an optionally substituted aryl group containing 6 to 12 carbon atoms (e.g., phenyl group or naphthyl group; examples of the substituents for these groups being the same as defined with respect to the above-described alkyl group, and the aryl group being optionally substituted by a plurality of the substituents), or an optionally fused hetero ring group containing at least one atom selected from the group consisting of nitrogen atom, oxygen atom and sulfur atom (examples of the hetero ring: pyran ring, furan ring, thiophene ring, morpholine ring, pyrrole ring, thiazole ring, oxazole ring, pyridine ring, piperidine ring, pyrrolidone ring, benzothiazole ring, benzoxazole ring, quinoline ring and tetrahydrofuran ring, which may optionally have a substituent or substituents; examples of the substituents being the same as defined with respect to the above-described alkyl group, and the hetero ring group being optionally substituted by a plurality of the substituents).

The reactive group Y preferably represents a hydroxy group, a halogen atom (fluorine atom, chlorine atom, bromine atom or iodine atom), —OR¹ group, —OCOR² group, CH(COR³) (COR⁴) group, —CH(COR³) (COOR⁴) group or —N(R⁵) (R6) group.

In the —OR¹ group, R¹ represents an optionally substituted aliphatic group containing 1 to 10 carbon atoms (e.g., methyl group, ethyl group, propyl group, butyl group, pentyl group, hexyl group, heptyl group, octyl group, nonyl group, decyl group, propenyl group, butenyl group, heptenyl group, hexenyl group, octenyl group, decenyl group, 2-hydroxyethyl group, 2-hydroxypropyl group, 2-methoxyethyl group, 2-(methoxyethyloxy)ethyl group, 2-(N,N-diethylamino)ethyl group, 2-methoxypropyl group, 2-cyanoethyl group, 3-methyloxypropyl group, 2-chloroethyl group, cyclohexyl group, cyclopentyl group, cyclooctyl group, chlorocyclohexyl group, methoxycyclohexyl group, benzyl group, phenethyl group, dimetoxybenzyl group, methylbenzyl group or bromobenzyl group).

In the —OCOR group, R preferably are the same as defined with respect to R′, and preferably represents an aliphatic group or an optionally substituted aromatic group (exemplified by those illustrated with respect to the aryl group in the foregoing R⁰).

In the —CH(COR³) (COR⁴) group and the —CH(COR³) (COOR⁴) group, R³ represents an alkyl group containing 1 to 4 carbon atoms (e.g., methyl group, ethyl group, propyl group or butyl group) or an aryl group (e.g., phenyl group, tolyl group or xylyl group), and R⁴ represents an alkyl group containing 1 to 6 carbon atoms (e.g., methyl group, ethyl group, propyl group, butyl group, pentyl group or hexyl group), an aralkyl group containing 7 to 12 carbon atoms (e.g., benzyl group, phenethyl group, phenylpropyl group, methylbenzyl group, methoxybenzyl group, carboxybenzyl group or chlorobenzyl group) or an aryl group (e.g., phenyl group, tolyl group, xylyl group, mesityl group, methoxyphenyl group, chlorophenyl group, carboxyphenyl group or diethoxyphenyl group).

In the —N(R⁵) (R⁵) group, R⁵ and R⁶are the same or different from each other, and each preferably represent a hydrogen atom or an optionally substituted aliphatic group containing 1 to 10 carbon atoms (e.g., those illustrated with respect to R′ in the —OR′ group), with sum of the carbon atoms of R⁵ and R⁶ being preferably 12 or less.

The metal M is preferably a transition metal, a rare earth metal or a metal belonging to the group III to V of the periodic table, with Al, Si, Sn, Ge, Ti or Zr being more preferred. Of these, Al, Si, Ti or Zr is much more preferred, with Si being most preferred.

As specific examples of the metal compound represented by the general formula (I), there are illlustrated the following compounds which, however, are not limitative at all.

Methyltrichlorosilane, methyltribromosilane, methyltrLmethoxysilane, methyltriethoxysilane, methyltriisopropoxysilane, methyltri-t-butoxysilane, ethyltrichlorosilane, ethyltribromosilane, ethyltrimethoxysilane, ethyltriethoxysilane, ethyltriisopropoxysilane, ethyltri-t-butoxysilane, n-propyltrichlorosilane, n-propyltribromosilane, n-propyltrimethoxysilane, n-propyltriethoxysilane, n-propyltriisopropoxysilane, n-propyltri-t-butoxysilane, n-hexyltrichlorosilane, n-hexyltribromosilane, n-hexyltrimethoxysilane, n-hexyltriethoxysilane, n-hexyltriisopropoxysilane, n-hexyltri-t-butoxysilane, n-decyltrichlorosilane, n-decyltribromosilane, n-decyltrimethoxysilane, n-decyltriethoxysilane, n-decyltriisopropoxysilane, n-decyltri-t-butoxysilane, n-octadecyltrichlorosilane, n-octadecyltribromosilane, n-octadecyltrimethoxysilane, n-octadecyltriethoxysilane, n-octadecyltriisopropoxysilane, n-octadecyltri-t-butoxysilane, phenyltrichlorosilane, phenyltribromosilane, phenyltrimethoxysilane, phenyltriethoxysilane, phenyltriisopropoxysilane, phenyltri-t-butoxysilane, tetrachlorosilane, tetrabromosilane, tetramethoxysilane, tetraethoxysilane, tetraisopropoxysilane, tetrabutoxysilane, dimethoxydiethoxysilane, dimethyldichlorosilane, dimethyldibromosilane, dimethyldimethoxysilane, dimethyldiethoxysilane, diphenyldichlorosilane, diphenyldibromosilane, diphenyldimethoxysilane, diphenyldiethoxysilane, phenylmethyldichlorosilane, phenylmethyldibromosilane, phenylmethyldimethoxysilane, phenylmethyldiethoxysilane, triethoxyhydrosilane, tribromohydrosilane, tri-t-butoxyhydrosilane, trimethoxyhydrosilane, isopropoxyhydrosilane, vinyltrichlorosilane, vinyltribromosilane, vinyltrimethoxysilane, vinyltriethoxysilane, vinyltriisopropoxysilane, vinyltri-t-butoxysilane, trifluoropropyltrichlorosilane, trifluoropropyltribromosilane, trifluoropropyltrimethoxysilane, trifluoropropyltriethoxysilane, trifluoropropyltriisopropoxysilane, trifluoropropyltri-t-butoxysilane, γ-glycidoxypropylmethyldimethoxysilane, γ-glycidoxypropylmethyldiethoxysilane, γ-glycidoxypropyltrimethoxysilane, γ-glycidoxypropyltriethoxysilane, γ-glycidoxypropyltriisopropoxysilane, γ-glycidoxypropyltri-t-butoxysilane, γ-methacryloxypropylmethyldimetoxysilane, γ-methacryloxypropylmethyldiethoxysilane, γ-methacryloxypropyltrimethoxysilane, γ-methacryloxypropyltriisopropoxysilane, γ-methacryloxypropyltri-t-butoxysilane, γ-aminopropylmethyldimethoxysilane, γ-aminopropylmethyldieth oxysilane, γ-aminopropyltrimethoxysilane, γ-aminopropyltriethoxysilane, γ-aminopropyltriisopropoxysilane, γ-amino propyltri-t-butoxysilane, γ-minercaptopropylmethyldimethoxysilane, γ-mercaptopropylmethyldiethoxysilane, γ-mercaptopropyltrimethoxysilane, γ-mercaptopropyltriethoxysilane, γ-mercaptopropyltriisopropoxysilane, γ-mercaptopropyltri-t-butoxysilane, β-(3,4-epoxycyclohexyl)ethyltrimethoxysilane, β-(3,4-epoxycyclohexyl)ethyltriethoxysilane,

Ti(OR)₄ (wherein R represents a group such as methyl group, ethyl group, propyl group, butyl group, pentyl group or hexyl group), TiCl₄, Zn(OR)₂, Zn(CH₃COCHCOCH₃) 2, Sn(OR)₄, Sn(CH₃COCHCOCH₃)₄, Sn(OCOR)₄, SnCl₄, Zr(OR)₄, Zr(CH₃COCHCOCH₃)₄ and Al(OR)₃.

The above-described metal compounds are used independently or in combination for producing the metal-containing resins.

As the metal-containing resin having nitrogen atom-metal atom-nitrogen atom bonds, there is illustrated, for example, polysilazane.

In the invention, it is preferred to use, as a binder resin, a composite between the above-described metal-containing resin and an organicpolymer containing a group capable of forming a hydrogen bond with the resin. The term “composite between the metal-containing resin and the organic polymer” has themeaningofbothsol-likematerials and gel-like materials.

The organic polymer contains a group capable of forming a hydrogen bond with the metal-containing resin (hereinafter also referred to as “specific binding group”). As the preferable specific binding group, there are illustrated at least one bond selected from the group consisted of an amido group (including both carbonic acid amido bond and sulfonamido group), an urethane bond and an ureido bond, and a hydroxyl group.

As the organic polymer, there are illustrated those which contain the specific binding group of the invention in the main chain and/or side chain of the polymer as a repeating unit component. Preferably, there are illustrated those which contain at least one kind of bond selected from the group consisted of —N(R″¹¹)CO—, —N(R¹¹”)SO₂—, —NHCONH— and —NHCOO— in the main chain and/or side chain of the polymer, and/or those which contain a OH group, as a repeating unit component. R¹″ in the amido bond represents a hydrogen atom or an organic residue which is the same as the hydrocarbyl group and the hetero ring group of R⁰ in the general formula (I).

As the polymer containing the specific binding group of the invention in the polymer main chain, there are illustrated amide resins containing —N(R¹¹″)CO— bond or —N(R″¹¹)SO₂— bond, ureide resins containing —NHCONH— bond and urethane resins containing —NHCOO— bond.

As diamines and dicarboxylic acids or disulfonic acids to be used for producing the amide resins, diisocyanates to be used for the ureide resins, and diols to be used for the urethane resins, those compounds may be used which are described in, for example, “Kobunshi Data Handbook—Kisohen—, Dai-I-Sho”, compiled by Kobunshi Gakkai and published by K. K. Baifukan in year 1986 and “Kakyozai Handbook” compiled by Sinzo Yamasita & Tosuke Kaneko and published by Taiseisha in year 1981.

In addition, as the polymer containing other amido bond, there are illustrated polymers containing a repeating unit represented by the following general formula (II), N-acylated polyalkyleneimines, and polyvinylpyrrolidone and its derivatives.

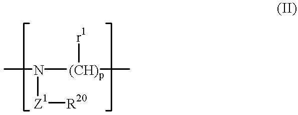

In the formula (II), Z¹ represents —CO—, —SO₂— or —CS—. R²⁰ is the same as defined for R⁰intheformula (I). r¹ represents a hydrogen atom or an alkyl group containing 1 to 6 carbon atoms (e.g., methyl group, ethyl group, propyl group, butyl group, pentyl group or hexyl group). r¹ may be the same or different. p represents an integer of 2 or 3.

Of the polymers containing the repeating unit represented bythe general formula (II), thosepolymers wherein Z¹ represents —CO— bond and p represents 2 may be obtained by ring-opening polymerization of an optionally substituted oxazoline in the presence of a catalyst. As the catalyst, there may be used, for example, sulfuric acid esters or sulfonic acid esters such as dimethyl sulfate or alkyl p-toluenesulfonate; alkyl halides such as alkyl iodide (e.g., methyl iodide); metal fluorides of Friedel-Crafts catalysts; acids such as sulfuric acid, hydrogen iodide or p-toluenesulfonic acid; and oxazolinium salts between these acids and oxazoline. Additionally, these polymers may be homopolymers or copolymers. In addition, they maybe graft copolymers wherein these polymers are grafted onto other polymers.

As specific examples of oxazoline, there are illustrated 2-oxazoline, 2-methyl-2-oxazoline, 2-ethyl-2-oxazoline, 2-propyl-2-oxazoline, 2-isopropyl-2-oxazoline, 2-butyl-2-oxazoline,2-dichloromethyl-2-oxazoline, 2-trLchloromethyl-2-oxazoline, 2-pentafluoroethyl-2-oxazoline, 2-phenyl-2-oxazoline, 2-methoxycarbonylethyl-2-oxazoline, 2-(4-methylphenyl)-2-oxazoline and 2-(4-chlorophenyl)-2-oxazoline.

Preferable oxazolines include 2-oxazoline, 2-methyl-2-oxazoline and 2-ethyl-2-oxazoline. Polymers of such oxazolines may be used alone or in combination of two or more of them.

Other polymers containing the repeating unit represented by the general formula (II) may be obtained in the same manner using thiazoline, 4,5-dihydro-1,3-oxazine or 4,5-dihydro-1,3-thiazine in place of oxazoline.

As the N-acylated polyalkyleneimines, there are illustrated carbonic acid amides containing —N(CO—R²⁰)— and being obtained by high molecular reaction with a caroxylic acid halide, and sulfonamides containing —N(SO₂—R²⁰)— and being obtained by high molecular reaction with a sulfonyl halide. R²⁰ is the same as defined with respect to R²⁰ of the formula (II).

In addition, as the polymers containing the specific binding group in the side chain of the polymer, there are illustrated those which contain, as a major component, a component containing at least one kind of the binding group selected from the specific binding groups. As such component, there are illustrated, for example, acrylamide, methacrylamide, crotonamide, vinylacetic acid amide and the following compounds, which, however, are not limitative at all.

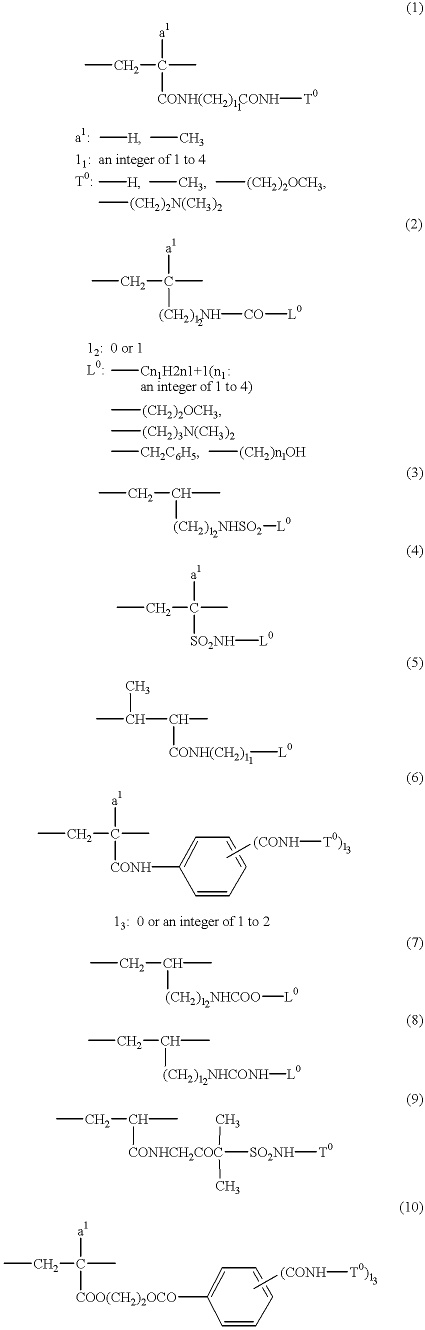

On the other hand, as the hydroxyl group-containing organic polymers, any of natural water-soluble polymers, semi-synthetic water-soluble polymers and synthetic polymers may be used. Specifically, there are illustrated those described in “Dai-Yukikagaku 19, Tennen Kobunshi Kagoubutu I” supervised by Munio Kotake and published by Asakura Shoten in year 1960, “Suiyosei Kobunshi/Mizubunsan-gata Jushi Sogo Gijutsu Shiryoshu” compiled and published by Keiei Kaihatsu Center Shuppanbu in year 1981, “Shin-Suiyosei Polymer No Oyo To Shijo” by Shinji Nagatomo and published by K. K. CMC in year 1988 and “Kinosei Cellulose No Kaihatsu” published by K. K. CMC in year 1985.

For example, as the natural and semi-synthetic high polymers, there are illustrated cellulose, cellulose derivatives (cellulose esters such as cellulose nitrate, cellulose sulfate, cellulose acetate, cellulose propionate, cellulose succinate, cellulose butyrate, cellulose acetate succinate, cellulose acetate butyrate and cellulose acetate phthalate; and cellulose ethers such as methyl cellulose, ethyl cellulose, cyanoethyl cellulose, carboxymethyl cellulose, hydroxyethyl cellulose, hydroxypropyl cellulose, ethylhydroxyethyl cellulose, hydroxypropylmethyl cellulose and carboxymethylhydroxyethyl cellulose), starch, starch derivatives (e.g., oxidized starch; esterified starches such as starches esterified with nitric acid, sulfuric acid, phosphoric acid, acetic acid, propionic acid, butyric acid or succinic acid; and etherified starches such as methylated starch, ethylated starch, cyanoethylated starch, hydroxyalkylated starch and carboxymethylated starch), alginic acid, pectin, carrageenan, tamarind gum, natural gums (e.g., gumarabic, Guar rum, locast bean gum, tragacanth gum and xanthane gum), pullulan, dextran, casein, gelatin, chitin and chitosan.

As the synthetic polymers, there are illustrated polyvinyl alcohol, polyalkylene glycol (e.g., polyethylene glycol, polypropylene glycol and (ethylene/propylene glycol) copolymer), allyl alcohol copolymers, acrylic or methacrylic acid ester homopolymers or copolymers having at least one hydroxyl group (substituents for the ester moiety being exemplified by 2-hydroxyethyl group, 3-hydroxypropyl group, 2, 3-dihydroxypropyl group, 3-hydroxy-2-hydroxymethyl-2-methylpropyl group, 3-hydroxy-2,2-di(hydroxymethyl)propyl group, polyoxyethylene group and polyoxypropylene group), and homopolymers or copolymers of N-substituted acrylamides or methacrylamides (examples of N-substutuent: monomethylol group, 2-hydroxyethyl group, 3-hydroxypropyl group, 1,1-bis(hydroxymethyl)ethyl group and 2,3,4,5,6-pentahydroxypentyl group). However, the synthetic polymers are not particularly limited as long as at least one hydroxyl group is contained in the side chain substituent of the repeating unit.

The organic polymer to be used in the invention has a weight average molecular weight of preferably 103 to 106, more preferably 5×10³ to 4×10⁵ .

In the composite comprising the metal-containing resin and the organic polymer, the ratio of the metal-containing resin to the organic polymer may be selected from a wide range, and is preferably 10/90 to 90/10, more preferably 20/80 to 80/20, in weight ratio of metal-containing resin/organic polymer.

In the case of using, for example, the binder resin containing the composite wherein the metal-containing resin is that prepared by hydrolytic polycondensation of the metal compound, a uniform organic-inorganic hybrid is formed by hydrogen bond effect between the hydroxyl group and the specific binding group in the organic polymer, thus microscopic uniformity being attained without phase separation. When the metal-containing resin possesses a hydrocarbyl group, affinity for the organic polymer seems to be more improved due to the existence of the hydrocarbyl group. Since the composite has both organic and inorganic properties, it shows a strong mutual action on both inorganic particles and organic particles, thus the binder resin strongly adsorbing onto the particles. In addition, this composite shows excellent filming properties.

The composite between the metal-containing resin and the organic polymer may be prepared by hydrolytically polycondensing the metal compound, then mixing the product with the organic polymer, or by conducting hydrolytic polycondensation of the metal compound in the presence of the organic polymer.

Preferably, the organic-inorganic polymer composite can be obtained by hydrolytic polycondensation of the metal compound according to sol-gel process in the presence of the organic polymer. In the produced organic-inorganic polymer composite, the organic polymer is uniformly distrubuted in the gel matrix produced by hydrolytic polycondensation of the metal compound (that is, three-dimensional fine network structure of the inorganic metal oxide).

The sol-gel process referred to the preferred process can be conducted according to conventionally known sol-gel process. Specifically, the process can be conducted according to the descriptions given in such books as “Sol-gel Ho Niyoru Hakumaku Coating gijutsu” published by K. K. Gijutsu Joho Kyokai in year 1995, “Sol-gel Ho No Kagaku” by Sumio Sakuhana and published by K. K. Agunesu Shofu-sha in year 1988 and “Saisin Sol-gel Ho Niyoru Kinosei Hakumaku Sakusei Gijutsu” by Seki Hirajima and published by Sogo Gijutsu Center in year 1992.

Solvents to be used for forming the uneven surface are properly selected from water and organic solvents. As the organic solvents, there are illustrated alcohols (methanol, ethanol, propyl alcohol, ethylene glycol, diethylene glycol, propylene glycol, dipropylene glycol, ethylene glycol monomethyl ether, propylene glycol monomethyl ether and ethylene glycol monoethyl ether), ethers (tetrahydrofuran, ethylene glycol dimethyl ether, propylene glycol dimethyl ether and tetrahydropyran), ketones (acetone, methyl ethyl ketone and acetylacetone), esters (methyl acetate and ethylene glycol monomethyl monoacetate) and amides (formamide, N-methylformamide, pyrrolidone and N-methylpyrrolidone). These solvents may be used alone or in combination of two or more of them.

Further, in the case of using the composite, an acidic or basic catalyst is preferably used in order to accelerate the hydrolysis and polycondensation reaction of the metal compound represented by the general formula (I).

As the catalyst, acids or basic compounds may be used also as a solution in water or a solvent such as alcohol (hereinafter referred to as acidic catalysts and basic catalysts, respectively). Concentration of the catalyst in the solution is not particularly limited, but a solution of a higher concentration tends to raise the rate of hydrolysis and polycondensation. However, use of a basic catalyst of a high concentration can cause generation of a precipitate in the sol solution, and hence concentration of the basic catalyst is desirably 1 N(mol/L) (in terms of concentration as an aqueous solution) or less.

Kinds of the acidic or basic catalysts are not particularly limited but, in case that it is necessary to use the catalyst at a high concentration, those catalysts are preferred which are constituted by elements scarcely remaining in the catalyst crystal particles after baking. Specifically, there are illustrated acidic catalysts such as hydrogen halide (e.g., hydrochloric acid), nitric acid, sulfuric acid, sulfurous acid, hydrogen sulfide, perchloric acid, hydrogen peroxide, carbonic acid, carboxylic acid (e.g., formic acid or acetic acid), substituted carboxylic acid of RCOOH wherein R is substituted by other element or substituent, sulfonic acid (e.g., benzenesulfonic acid) and basic catalysts such as ammoniacal base (e.g., aqueous ammonia) and amine (e.g., ethylamine or aniline).

The binder resin is used in an amount of generally 8 to 50 parts by weight, preferably 10 to 30 parts by weight, per 100 parts by weight of the particles. The effects of the invention are effectively obtained by using the binder resin in an amount of this range.

In addition, a cross-linking agent may be added. As the cross-linking agent, there are illustrated those which are commonly used as cross-linking agents. To be specific, those compounds may be used which are described in “Kakyozai Handbook” compiled by Shinzo Yamasita and Tosuke Kaneko published by Taiseisha in year 1981 and “Kobunshi Data Handbook, Kiso-hen” compiled by Kobunshi Gakkai and published by Baifukan in year 1986.

For example, there are illustrated ammonium chloride, metal ions, organic peroxides, polyisocyanate compounds (e.g., toluilene diisocyanate, diphenylmethanediisocyanate, triphenylmethane triisocyanate, polymethylenephenyl isocyanate, hexamethylenediisocyanate, isophorone diisocyanate and high molecular polyisocyanate), polyol compounds (e.g., 1,4-butanediol, polyoxypropylene glycol, polyoxyethylene glycol and 1,1,1-trimethylolpropane), polyamine compounds (e.g., ethylenediamine, γ-hydroxypropylated ethylenediamine, phenylenediamine, hexamethylenediamine, N-aminoethylpiperazine and modified aliphaticpolyamine), polyepoxygroup-containingcompoundsand epoxy resins (e.g., those compounds which are described in “Shin-epoxy Jushi” compiled by Hiroshi Kakiuchi and published by Shokodo in year 1985 and “Epoxy jushi” compiled by Kuniyuki Hashimoto and published by Nikkan Kogyo Shinbun-sha in year 1969), melamine resins (e.g., compounds described in “Urea/melamine Jushi” compiled by Ichiro Miwa & Hideo Matsunaga and published by Nikkan Kogyo Shinbun-sha in year 1969), and poly(meth)acrylate compounds (e.g., compounds described in “Oligomer” compiled by Shin Okawara, Takeo Saegusa & Toshinobu Higashimura and published by Kodansha in year 1976 and “Kinosei Acryl Kei jushi” compiled by Eizo Omori and published by Tekunosisutemu in year 1985).

In the invention, an overcoat layer may be provided on the uneven surface. The overcoat layer comprises a filming resin and, as the resin, the same ones as have been described with respect to the binder resin for forming the uneven surface maybe used. Preferably, in order to attain good adhesion with the uneven surface, a hydrophilic overcoat layer is used for an uneven surface containing a hydrophilic binder resin, and a hydrophobic overcoat layer is used for an uneven surface containing a hydrophobic binder resin.

The overcoat layer may be formed by coating a coating solution containing the filming resin and the solvent onto the uneven surface according to a conventionally known coating method, followed by drying. As the solvent, the aforesaid solvent may properly be used. As the coating method, there are illustrated a coater coating method (air doctor coating, blade coating, rod coating, squeeze coating or gravure coating) and a spray coating method (air spraying or electrostatic spraying).

The uneven surface of the block copy sheet in the invention has a center-line average roughness Ra of preferably 20 μm or less, more preferably 12 μm or less, most preferably less than 2 μm. Such roughness serves to prevent stain of non-image area after printing. In addition, the uneven surface of the block copy sheet has a ratio of Ra/Rz (Rz: ten-point average roughness) of preferably less than 0.17. Such ratio serves to obtain better effects of preventing elongation and positional deviation of the printing plate.

On the other hand, the uneven surface may also be formed on the back surface of the lithographic printing plate of the invention in the same manner as with the block copy sheet. In addition, the overcoat layer maybe similarly provided as well.

The uneven back surface of the lithographic printing plate of the invention has a center-line average roughness (Ra) of preferably 20 μm or less, more preferably 12 μm or less, and particularly preferably less than 1.5 μm. Surface roughness of less than 1.5 μm makes it difficult to cause print stain and form flaws on the surface of lithographic printing plate, thus being preferred.

Further, sum of Ra of the uneven front surface of the block copy sheet and Ra of the uneven back surface of lithographic printing plate is preferably 20 μm to 0.1 μm, more preferably 12 μm to 0.1 μm, particularly preferably 3.5 μm to 0.1 μm.

The block copy sheet of the invention is fixed to a plate cylinder in a conventionally known manner. For example, there are illustrated a method of applying an adhesive or a tackifier such as a spray adhesive or an adhesive double-coated tape onto the back side of the support of block copy sheet or a method of fixing a head portion and an end portion of the block copy sheet by a gripping member provided on the plate cylinder. It is also possible to employ combination of these methods.

Upon printing using a lithographic printing machine, the lithographic printing plate is mounted on a plate cylinder with the block copy sheet of the invention intervening therebetween. In this situation, mounting is conducted so that the uneven surface of the block copy sheet faces the uneven back surface of the lithographic printing plate, whereby the uneven surfaces anchor to each other when pressure is applied to the block copy sheet and the lithographic printing plate upon printing. Thus, positional deviation and elongation of the lithographic printing plate on the plate cylinder to be caused by the force generating due to difference in spherical speed between the plate cylinder and the blanket cylinder during printing can be avoided.

The invention is described in more detail by reference to Examples which, however, do not limit the invention in any way.

### EXAMPLE 1

<Preparation of Block Copy Sheet for Lithographic Printing Plate>

5 g of polyvinyl alcohol PVA405 (manufactured by Kuraray Co. Ltd.) was added to 50 g of water under stirring, and the stirring was continued for 30 minutes. 3 g of tetramethoxysilane (manufactured by Shin-Etsu Chemical Co., Ltd.) was added to this solution and, after stirring for 30 minutes, 1 ml of conc. hydrochloric acid was added thereto, followed by stirring for 2 hours. Further, glass particles GB731 (manufactured by Toshiba Glass K.K.; average particle size: 30 μm) were added thereto, and the mixture was placed in a paint shaker (manufactured by Toyo Seiki K. K.) together with glass beads and, after dispersing for 10 minutes, the glass beads were filtered off to obtain a dispersion. This dispersion was coated on the surface of a 100-μm thick support (an initial elastic modulus: 450 kgf/mm²) composed of polyethylene terephthalate (PET) in an amount of 5 g/m² using a wire bar, dried at 110° C. for 3 minutes to obtain a block copy sheet for lithographic printing. Center-line average roughness Ra of this uneven surface was 1.8 μm, and Ra/Rz was 0.10.

<Preparation of Printing Plate>

The same coating solution as used for preparing the block copy sheet for lithographic printing was coated on the back side of a silver diffusion light-sensitive material having a 100-μm thick polyethylene terephthalate (PET) support, Super Master Plus (total thickness: 130 μm) made by Agfa-Gevaert N. V. in an amount of 5 g/m² using a wire bar, and air-dried to obtain a lithographic printing plate having an uneven surface. Ra value of the uneven surface was 1.2 μm.

### COMPARATIVE EXAMPLE 1

Evaluation of printing was conducted using only the block copy sheet for lithographic printing prepared in Example 1.

Evaluation of printing was conducted using only the lithographic printing plate having an uneven back side.

<Evaluation of Printing>

A lithographic printing plate was obtained from a silver diffusion light-sensitive material having a 100-μm thick polyethylene terephthalate (PET) support, Super Master Plus (total thickness: 130 μm) made by Agfa-Gevaert N. V., whose back side was coarsened as described above, using an exclusive plate maker SPM415 was used. Additionally, the lithographic printing plate can also be obtained by electrophotographic plate-making process.

Then, the thus obtained block copy sheet and the lithographic printing plate were respectively cut into a piece of 560 mm in width and 400 mm in length, and the thus cut lithographic printing plate and the block copy sheet were superposed so that the uneven back side of the lithographic printing plate faced the uneven surface of the block copy sheet. The thus superposed lithographic printing plate and the block copy sheet were adhered onto the plate cylinder of a one-side printing machine Oliver 52 manufactured by Sakurai K. K., and 2000 printed products were made. The printing procedure was repeated 10 times in the same manner, and positional deviation of the plate and removal of the particles were evaluated with the 10th printed product according to the following methods.

The surface of the lithographic printing plate was squeezed, before printing, with a sponge soaked with a processing solution G671c. A fountain solution on the printing machine is prepared by diluting the processing solution G671c with water (1:1) was used and, as an ink, New Champion F Gloss85manufactured by Dai Nippon Ink & Chemicals Co. Ltd. was used.

After printing, position of a rule printed on a printed product immediately after initiation of the printing was compared with position of the rule printed on a printed product after printing 10000 printed products to measure a positional deviation of the lithographic printing plate on the plate cylinder between the printed product immediately after initiation of printing and the printed product after making 10000 printed products. Further, upon completion of the printing, degree of removal of the particles on the surface of the block copy sheet was observed under an optical microscope and was visually evaluated. Results thus obtained are shown in Table 1.

Evaluation standards in each Table are as follows. Evaluation standards:

Elongation of plate:

<50 82 m . . . A;

50-100 μm . . . B;

>100 μm . . . C

Positional deviation of plate:

<50 μm . . . A;

50-100 μm . . . B;

>100 μm . . . C

Stain in non-image area:

none . . . A;

a little . . . B;

much . . . C.

TABLE 1

| | | Positional | |
|---|---|---|---|
| | Elongation of | Deviation of | Stain in |
| No. | Plate | Plate | Non-image Area |
| Ex. 1 | A | A | A |
| Com. Ex. 1 | B | B | A |
| Com. Ex. 2 | C | C | A |

It is seen from this result that printing can be conducted without elongation and positional deviation of the plate and without causing stain in non-image area by the method of Example 1. However, when only the block copy sheet for lithographic printing as shown in Comparative Example 1 is used, the uneven surface of the block copy sheet does not engage with the back side of the lithographic printing plate, and hence it becomes difficult to fix the lithographic printing plate, thus elongation and positional deviation of the plate being caused. In addition, as is shown in Comparative Example 2, coarsening only the back side of the lithographic printing plate fails to engage the surface with the plate cylinder, thus elongation and positional deviation of the plate being caused. Examples 2 to 17.

Coating materials for forming the uneven surface were prepared in the same manner as in Example 1 using the same binder except for changing kind of the particles/added amount thereof, and block copy sheets and lithographic printing plates having a varying surface unevenness were prepared and evaluated.

TABLE 2

| | | | | | | Litho- |
|---|---|---|---|---|---|---|
| | | Added | | | Block | graphic |
| | Kind of | Amount | Ra | | Copy | Printing |
| No. | Particles | (g) | (μm) | Ra/Rz | Sheet | Plate |
| a | GB731 (30 μm) | 2 | 1.9 | 0.12 | a-s | a-p |
| b | GB731 (30 μm) | 4 | 4.5 | 0.35 | b-s | b-p |
| c | GB731 (30 μm) | 6 | 8.4 | 0.5 | c-s | c-p |
| d | Polystyrene | 4 | 1.1 | 0.1 | d-s | d-p |
| | (10 μm) | | | | | |
| e | Polystyrene | 6 | 1.4 | 0.15 | e-s | e-p |
| | (10 μm) | | | | | |
| f | Polystyrene | 10 | 4.2 | 0.21 | f-s | f-p |
| | (10 μm) | | | | | |

TABLE 3

| | Block Copy Sheet/ | | Positional | Stain in |
|---|---|---|---|---|
| | Lithographic | Elongation | deviation | non-image |
| No. | Printing plate | of plate | of plate | area |
| Ex. 2 | a-s/d-p | A | A | A |
| Ex. 3 | a-s/e-p | A | A | A |
| Ex. 4 | d-s/d-p | A | A | A |
| Ex. 5 | d-s/e-p | A | A | A |
| Ex. 6 | e-s/e-p | A | A | A |
| Ex. 7 | e-s/d-p | A | A | A |
| Ex. 8 | b-s/d-p | A | A | A to B |
| Ex. 9 | b-s/e-p | A | A | A to B |
| Ex. 10 | a-s/f-p | A | A | A to B |
| Ex. 11 | a-s/c-p | A | A | B |
| Ex. 12 | c-s/a-p | A | A | B |
| Ex. 13 | c-s/d-p | A | A | B |
| Ex. 14 | c-s/e-p | A | A | B |
| Ex. 15 | c-s/b-p | A | A | C |
| Ex. 16 | c-s/f-p | A | A | C |
| Ex. 17 | c-s/c-p | A | A | C |

It is seen in Examples 2 to 17 that unevenness formed on both of the block copy sheet and the lithographic printing plate serves to provide better results with respect to elongation and positional deviation of the plate in comparison with the case of forming unevenness only on one of them (Comparative Examples 1 and 2 described above).

It is seen that block copy sheets having a larger surface roughness causes the problem of stain in non-image area (Examples 15 to 17) and, from Examples 2 to 11, that even when the surface roughness is smaller, elongation and positional deviation of the plate and generation of stain in non-image area can 15 effectively be avided as in Example 1 by superposing the sheet and the plate with the rough surfaces facing each other.

According to the invention, elongation and positional deviation of the plate can surely be avoided by conducting printing with mounting, on a plate cylinder, a block copy sheet for lithographic printing having an uneven surface at least on one side thereof and a lithographic printing plate having an uneven surface so that the uneven surfaces face with each other.

Further, good images without stains in non-image area can be obtained by properly selecting surface roughness of the block copy sheet and surface roughness of the lithographic printing plate.

Although the invention has been described with respect to specific embodiments, the details are not to be construed as limitations, for it will become apparent that various embodiments, changes and modifications may be resorted to without departing from the spirit and scope thereof, and it is understood that such equivalent embodiments are intended to be included within the scope of this invention.

What is claimed is:

1. A lithographic printing method comprising:
disposing on a plate cylinder, a block copy sheet and a lithographic printing plate, in this order, wherein the block copy sheet has a front surface that is uneven, the lithographic printing plate has a back surface that is uneven, and the front surface of the block copy sheet and the back surface of the lithographic printing plate are opposed to each other; and
carrying out printing with the lithographic printing plate.

2. The lithographic printing method according to claim 1, wherein the front surface of the block copy sheet and the back surface of the lithographic printing plate are engaged with each other.

3. The lithographic printing method according to claim 1, wherein the front surface of the block copy sheet has a center-line average roughness: Ra of 20 μm or less.

4. The lithographic printing method according to claim 1, wherein the front surface of the block copy sheet has a center-line average roughness: Ra of 12 μm or less.

5. The lithographic printing method according to claim 1, wherein the front surface of the block copy sheet has a center-line average roughness: Ra of less than 2 μm.

6. The lithographic printing method according to claim 1, wherein the front surface of the block copy sheet has a ratio of a center-line average roughness: Ra to a ten-point average roughness: Rz (Ra/Rz) of less than 0.17.

7. The lithographic printing method according to claim 1, wherein the back surface of the lithographic printing plate has a center-line average roughness: Ra of 20 μm or less.

8. The lithographic printing method according to claim 1, wherein the back surface of the lithographic printing plate has a center-line average roughness: Ra of 12 μm or less.

9. The lithographic printing method according to claim 1, wherein the back surface of the lithographic printing plate has a center-line average roughness: Ra of less than 1.5 μm.

10. The lithographic printing method according to claim 1, wherein a sum of Ra of the front surface of the block copy sheet and Ra of the back surface of the lithographic printing plate is 20 μm to 0.1 μm.

11. The lithographic printing method according to claim 1, wherein the block copy sheet comprises a support, and the support has an initial elastic modulus of 350 kgf/mm² or more.

12. The lithographic printing method according to claim 1, wherein the uneven surface is obtained by coating on the support a dispersion where particles having an average particle size of 1 to 100 μm are dispersed in a binder resin.

13. The lithographic printing method according to claim 12, wherein the binder resin comprises an inorganic resin containing at least one bond structure selected from the group consisting of O—(M)—O, O—(M)—N and N—(M)—N, in which M represents a metal atom, O represents an oxygen atom and N represents a nitrogen atom.

14. The lithographic printing method according to claim 12, wherein the binder resin is a composite comprising an inorganic resin and an organic polymer containing a group capable of forming a hydrogen bond with the inorganic resin.

15. The lithographic printing method according to claim 14, wherein the group capable of forming a hydrogen bond with the inorganic resin is at least one selected from the group consisting of an amido group, an urethane group, an ureido group and a hydroxyl group.

16. The lithographic printing method according to claim 14, wherein the weight ratio of the inorganic resin to the organic polymer in the composite is 10/90 to 90/10.

17. The lithographic printing method according to claim 12, wherein the binder resin is used in an amount of 8 to 50 parts by weight, per 100 parts by weight of the particles.
